(19) United States
(12) Patent Application Publication
(10) Pub. No.: US 2025/0097472 A1
(43) Pub. Date: Mar. 20, 2025

(54) IMAGE DISPLAY SYSTEM SENDING COMPRESSED DATA OR ROW DATA

(71) Applicant: PixArt Imaging Inc., Hsin-Chu County (TW)

(72) Inventor: JR-KAI LIANG, Hsin-Chu County (TW)

(21) Appl. No.: 18/967,338

(22) Filed: Dec. 3, 2024

Related U.S. Application Data
(62) Division of application No. 17/878,060, filed on Aug. 1, 2022.

(51) Int. Cl. H04N 19/70; G09G 5/00; H04N 19/172

(52) U.S. Cl. CPC H04N 19/70; G09G 5/005; H04N 19/172

(57) ABSTRACT

There is provided an imaging system capable of reducing required system resource and increasing a frame update rate. The imaging system includes a host and a display device. The host selects to transmit compressed data or row data to the display device. When the display device identifies the row data being received, the row data is directly stored into a frame buffer for being shown on a display panel. When the display device identifies the compressed data being received, the compressed data is used to generate restored data to the frame buffer for being shown on the display panel.

### CROSS REFERENCE TO RELATED APPLICATION

The present application is a divisional application of U.S. Patent application Ser. No. 17/878,060 filed on Aug. 1, 2022, the disclosure of which is hereby incorporated by reference herein in its entirety.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be re-visited.

### BACKGROUND

### 1. Field of the Disclosure

This disclosure generally relates to an image display system and, more particularly, to an image display system whose host end transmits compressed image data to a display device thereof such that time intervals required for data storage and transmission are reduced and system elements having lower cost can be adopted.

### 2. Description of the Related Art

Please refer to FIG. 1, it is a schematic block diagram of a conventional image display system 100. The image display system 100 includes a micro controller unit (MCU) 11 of a host end and a display device 20.

When a flash 13 of the host end stores row data, the MCU 11 reads the row data from the flash 13, and then the row data is transmitted to a memory II (shown as MEM II) of the display device 20 via a transmission interface. The driver IC of the display device 20 reads the row data from the memory II to be shown on a display panel.

However, when the flash 13 of the host end stores compressed data, the MCU 11 firstly decompresses the compressed data to generate restored data, which is then stored in a memory I (shown as MEM I). Then, the restored data is transmitted to the memory II of the display device 20 via the transmission interface. The driver IC of the display device 20 reads the restored data from the memory II to be shown on the display panel.

With the increasing of resolution of the display device 20 and the changing of the display device 20 from monochromatic display displays to color displays, data amount required to be stored in the flash 13 and the memory I is gradually increased as well as higher processor capability is required such that the system resource requirement is also increased. Meanwhile, a time interval required for transmitting each image frame is also increased such that a frame update rate is decreased at the same time.

Accordingly, the present disclosure provides an image display system that uses a transmission interface to transmit compressed data and uses a display driver to decompress the compressed data. Because a display device of the image display system originally uses a frame buffer to store the whole image frame, in the case that display device needs to increase amount of displayed data, the system requirement at a host end needs not to be increased at the same time.

### SUMMARY

The present disclosure provides an image display system whose host selects to output compressed image data or non-compressed image data to a display device thereof.

The present disclosure provides an image display system including a host and a display device. The host has a micro controller unit (MCU) configured to transmit a switch signal indicating transmitted image data being row data or compressed data. The display device includes a switching element configured to store the row data into a memory according to the switch signal, or transmit the compressed data to a decompression unit to generate restored data, which is then stored into the memory.

### BRIEF DESCRIPTION OF THE DRAWINGS

Other objects, advantages, and novel features of the present disclosure will become more apparent from the following detailed description when taken in conjunction with the accompanying drawings.

FIG. 1 is a schematic block diagram of a conventional image display system.

FIG. 2 is a schematic block diagram of an image display system according to one embodiment of the present disclosure.

FIG. 3 is a flow chart of an operating method of an image display system according to one embodiment of the present disclosure.

FIG. 4 is a flow chart of another operating method of an image display system according to one embodiment of the present disclosure.

FIG. 5 is a schematic diagram of a displayed image of an image display system according to one embodiment of the present disclosure.

### DETAILED DESCRIPTION OF THE EMBODIMENT

It should be noted that, wherever possible, the same reference numbers will be used throughout the drawings to refer to the same or like parts.

The image display system of the present disclosure is adapted to transmit compressed data via a transmission interface to reduce the system resource (e.g., including memory space and processor capability) at a host end and to significantly reduce a required time interval for transmitting data. Furthermore, the image display system of the present disclosure further selects to transmit the compressed data or not according to an operation state of system.

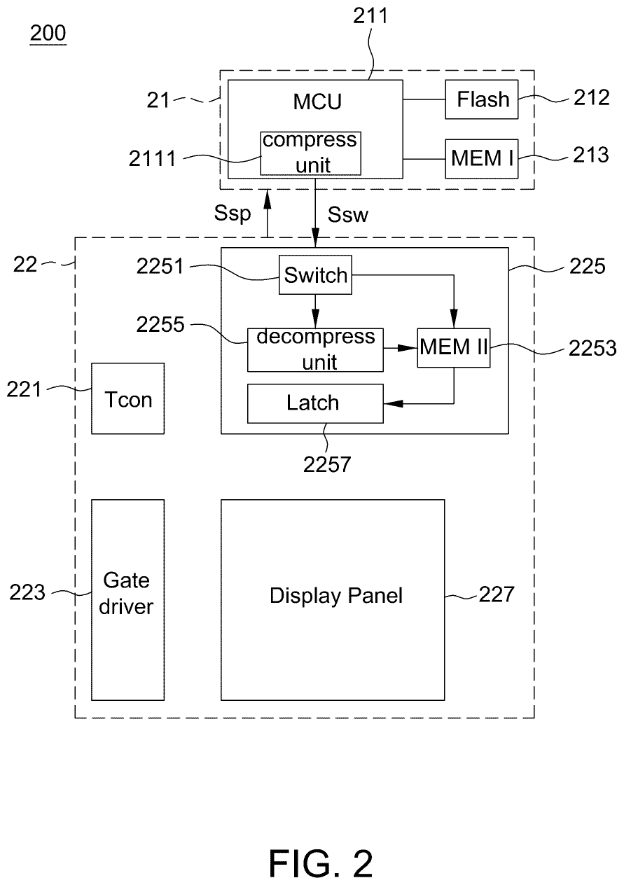

Please refer to FIG. 2, it is schematic block diagram of an image display system 200 according to one embodiment of the present disclosure. The image display system 200 includes a host 21 and a display device 22. The host 21 is a computer device such as a smartphone, a notebook computer, a tablet computer, but the present disclosure is not limited thereto. The display device 22 is a wearable electronic device having a display panel 227 such as a smart watch, a smart bracelet, smart glasses, but the present disclosure is not limited thereto.

The host 21 and the display device 22 exchange data therebetween via a wired or a wireless transmission interface, which is selected from a 8080 interface, a serial bus interface (SPI), an I2C interface and a mobile industry processor interface (MIPI), but the present disclosure is not limited thereto.

The host 21 includes a micro controller unit (MCU) 211, a flash 212 and a first memory (e.g., RAM) 213, shown as MEM I. In one aspect, the MCU 211 reads image data from the flash 212 and sends the image data to the display device 22 via the transmission interface. In another aspect, the MCU 211 reads image data from the flash 212 to be stored into the first memory 213 for further processing, e.g., characters and images overlapping processing, and then the processed image data is sent to the display device 22 via the transmission interface.

In the present disclosure, the MCU 211 selects to read row data or compressed data from the flash 212 to be transmitted to the display device 22. In addition, the MCU 211 further sends a switch signal Ssw to the display device 22 via the transmission interface, and the switch signal Ssw indicates the image data to be transmitted being the row data or the compressed data. The switch signal Ssw is transmitted previous to the image data transmission or embedded in the image data being transmitted without particular limitations.

In one aspect, the compressed data is stored into the flash 212 directly in a compressed status, i.e. not generated by compression process of the MCU 211. In another aspect, the compressed data is generated by compressing predetermined row data using a compression unit 2111 (shown as compress unit) of the MCU 211 and stored into the flash 212. That is, the image data is compressed before being sent by the MCU 211 without particularly limited to any time point.

In the present disclosure, the compressed data includes at least one of a base map, wallpaper and a fixed (i.e. no changing within a predetermined time interval) image file, characters and values within a displayed image (e.g., 50 in FIG. 5) to be shown on the display panel 227; whereas, the row data includes an image file, characters or values changing with time, but the present disclosure is not limited thereto. It is possible to previously determine the row data needs to be compressed.

The display device 22 includes a timing controller (Shown as Tcon) 221, a gate driver 223, a display driver (or called source driver) 225 and a display panel 227. The display panel 227 is, for example, a thin film transistor (TFT) display or an organic light-emitting diodes (OLED) display without particular limitations. The operations of the timing controller 221, the gate driver 223 and the display panel 227 are known to the art and not a main objective of the present disclosure, and thus details thereof are not described herein. The display driver 225 is used to show image data (including row data and compressed data) received form the host 21 on the display panel 227.

The display driver 225 of the display device 22 is coupled to the MCU 211 via the transmission interface, and includes a switching element 2251 (shown as Switch), a second memory (e.g., RAM) 2253 shown as MEM II, a decompression unit 2255 (shown as decompress unit) and multiple latches 2257, wherein the multiple latches 2257 temporarily store image data read from the second memory 2253 corresponding to pixel positions on the display panel 227 before being shown on a screen of the display panel 227. The corresponding operations of the multiple latches 2257 and the display panel 227 are known to the art and not a main objective of the present disclosure, and thus details thereof are not described herein.

The switching element 2251 is, for example, a multiplexer or a transistor switch, and is used to store the row data directly into the second memory 2253 according to the switch signal Ssw, or to transmit the compressed data to the decompression unit 2255 to generate restored data to be stored into the second memory 2253. The image data stored in the second memory 2253 is corresponding to the display panel 227, and the image data is shown on the display panel 227 via the multiple latches 2257 according to control signals of the timing controller 21 and the gate driver 221.

That is, when the switch signal Ssw indicates that data transmitted by the MCU 211 is row data which can be directly shown on the display panel 227, the row data is directly sent to the second memory 2253 waiting to be shown. When the switch signal Ssw indicates that data transmitted by the MCU 211 is compressed data which needs to be decompressed, the compressed data is firstly restored by the decompression unit 2255 and then sent to the second memory 2253 waiting to be shown. It is appreciated that the display device 22 previously knows the compression algorithm used by the host 21, and thus is embedded with a corresponding decompression algorithm to decompress the compressed data from the host 21.

In one aspect, the image display system 200 transmits compressed data to the display device 22 only in a low power interval (or called low power state or low power mode), but transmits only row data to the display device 22 in a normal display interval (or called normal state or normal mode). For example, the low power state is automatically entered when surplus power of the display device 22 is lower than a predetermined percentage or entered according to a user command (e.g., pressing a button or clicking an icon).

In one aspect, the display driver 225 sends a low power signal Ssp to the MCU 211 of the host 21 when the display device 21 enters the low power state. The MCU 211 is used to receive the low power signal Ssp to accordingly transmit In the low power state, the display driver 225 row data or compressed data. receives compressed data from the MCU 211 of the host 21, and the compressed data is sent to the decompression unit 2255 for generating restored data, which is then stored into the second memory 2253. In the normal state, the display driver 225 receives row data from the MCU 211 of the host 21, and the row data is directly (without further processing) stored into the second memory 2253.

In other words, the switching element 2251 automatically controls a transmitted destination of the received image data according to an operation status of the display device 22. Or, the switching element 2251 controls the transmitted destination of the received image data according to a switch signal Ssw sent from the host 21 as mentioned above.

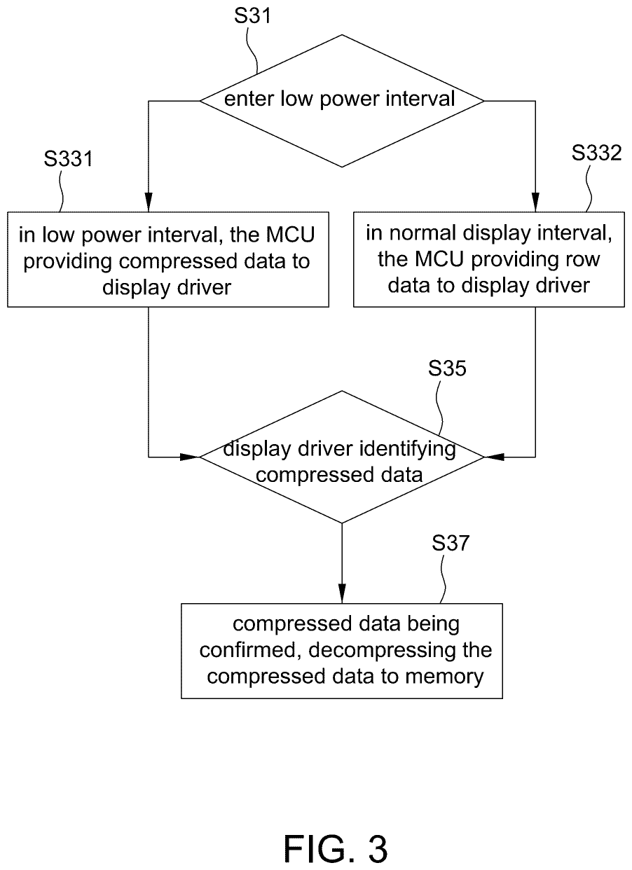

For example referring to FIG. 3, it is a flow chart of an operating method of an image display system 200 according to one embodiment of the present disclosure, including steps:

Step S31: Identifying whether the display device 22 enters a low power interval or not. As mentioned above, the display device 22 is arranged to automatically or manually enter the low power interval. Meanwhile, the display device 22 informs the host 21 regarding the low power interval being entered using a low power signal Ssp.

Step S332: If the display device 22 does not enter the low power interval, the MCU 211 provides row data to the display driver 225. The display driver 225 puts the row data directly into the second memory 2253 for being shown on the display panel 227.

Step S331: If the display device 22 enters the low power interval, the MCU 211 provides compressed data (e.g., compressed by the compression unit 2111 or not compressed by the compression unit 2111) to the display driver 225.

Step S35: In one aspect, when the display device 22 enters the low power interval, it means the MCU 211 will transmit compressed data, e.g., informing the host 21 using a low power signal Ssp. In another aspect, the display device 22 knows the compressed data being transmitted according to a switch signal Ssw from the host 21.

Step S37: After the display driver 225 restores the compressed data, the restored data is then stored into the second memory 2253 for being shown on the display panel 227.

Please refer to FIG. 5, it is a schematic diagram of a displayed image 50 of an image display system 200 according to one embodiment of the present disclosure. In another aspect, the MCU 211 is used to transmit a first display region of the displayed image 50 using compressed data, and to transmit a second display region of the displayed image 50 using row data. For example, the MCU 211 directly transmits image data of the second display region, and uses the compression unit 2111 to compress image data of the first display region, e.g., the compressed data associated with the first display region is firstly stored into the first memory 213 and then moved to the display device 22.

The switching element 2251 of the display device 22 is used to store the row data associated with the first display region directly into the second memory 2253, and transmits the compressed data associated with the second display region to the decompression unit 2255 to generate restored data, which is then stored into the second memory 2253. As mentioned above, the switching element 2251 identifies a type of the received data according to a switch signal Ssw from the host 21.

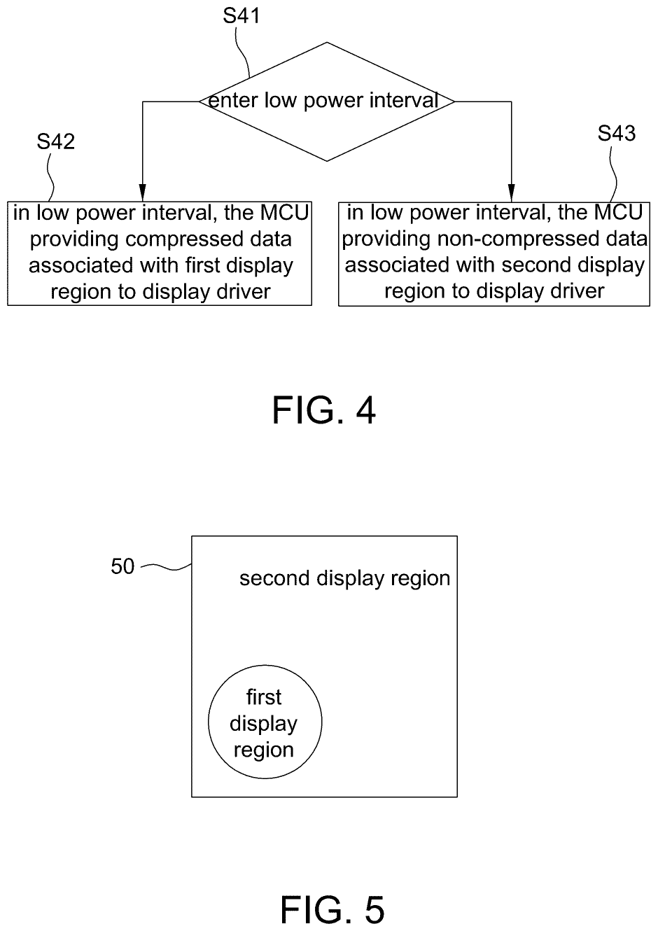

As shown in FIG. 4, in one aspect, the display device 22 determines whether to enter a low power interval (Step S41). As mentioned above, the display device 22 automatically or manually enters the low power interval. The compression unit 2111 of the host 21 provides compressed data associated with a first display region to the display driver 225 in the low power interval (Step S42); and provides non-compressed data (i.e. row data) associated with a second display region to the display driver 225 in the low power interval (Step S43).

In other words, the compression unit 2111 of the host 21 compresses data associated with the first display region of a displayed image 50 in a low power mode, but does not compress the data associated with the first display region of the displayed image 50 in a normal mode. The data of the second display region of the displayed image 50 is always not compressed before transmission.

It is appreciated that the first display region and the second display region in FIG. 5 are only intended to illustrate but not to limit the present disclosure. In one aspect, the first display region and the second display region are respectively a partial region of one displayed image 50. It is appreciated that the host 21 is embedded with hardware and/or firmware to separate different regions, e.g., the first display region and the second display region, of one displayed image 50.

In the present disclosure, a compression rate of the compressed data is determined according to different compressing algorithms, preferably between ⅕ and 1/20, but the present disclosure is not limited thereto.

In the present disclosure, the compression unit 2111 and the decompression unit 2255 are implemented by hardware and/or firmware.

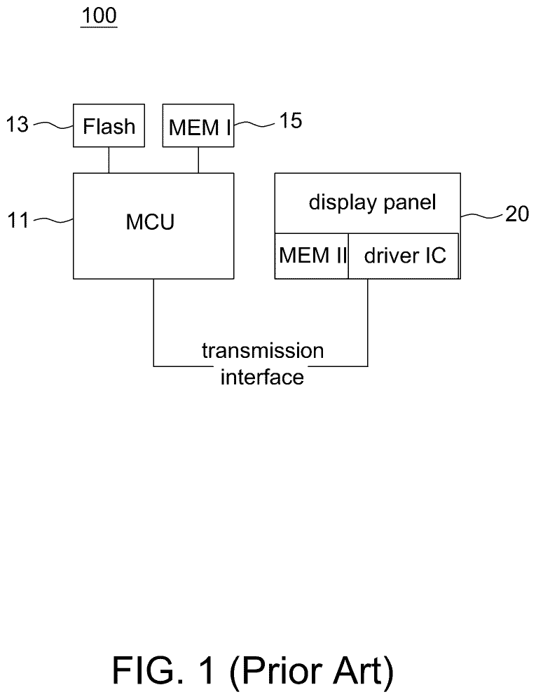

As mentioned above, the convention image display system uses an transmission interface to transmit non-compressed data such that the memory space at a host end and the processor capability have higher requirement. Furthermore, a long transmission time is required such that a frame update rate of display screens can be reduced. Accordingly, the present disclosure further provides an image display system having low system requirement (e.g., FIG. 1) and an operating method thereof (referring to FIGS. 3 to 4) that compress specific image data so as to effectively reduce the data transmission time without increasing memory space and processor capability at the host end.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

What is claimed is:

1. An image display system, comprising:
a host, comprising:
a micro controller unit (MCU), configured to transmit a switch signal indicating transmitted image data being row data or compressed data; and
a display device, comprising:
a memory;
a decompression unit; and
a switching element, configured to store the row data into the memory according to the switch signal, or transmit the compressed data to the decompression unit to generate restored data, which is then stored into the memory.

2. The image display system as claimed in claim 1, wherein the host further comprises a flash configured to store the compressed data and the row data.

3. The image display system as claimed in claim 2, wherein the compressed data is
directly stored into the flash at a compressed status, or
generated by compressing predetermined row data using a compression unit of the MCU and then stored into the flash.

4. The image display system as claimed in claim 1, wherein
the host is configured to transmit the row data or the compressed data to the display device via a transmission interface, and
the transmission interface is selected from a 8080 interface, an SPI interface, an I2C interface and an MIPI interface.

5. The image display system as claimed in claim 1, wherein the compressed data comprises at least one of a base map, wallpaper and a fixed image file within a displayed image to be shown on the display device.

6. The image display system as claimed in claim 1, wherein the row data comprises an image file, characters or values changing with time.

7. The image display system as claimed in claim 1, wherein
the host is a smartphone, a notebook computer or a tablet computer, and
the image display device is a wearable electronic device.

8. The image display system as claimed in claim 1, wherein the switch signal is sent prior to the transmitted image data.

9. The image display system as claimed in claim 1, wherein
the compressed data is transmitted only in a low power state, and
the row data is transmitted only in a normal state.

10. The image display system as claimed in claim 9, wherein
the display device is configured to send a low power signal to the host upon entering the low power state, and
the host is configured to transmit the compressed data after receiving the low power signal.

11. The image display system as claimed in claim 1, wherein the host further comprises a flash and a first memory, and
the MCU is further configured to read image data from the flash to be stored into the first memory for characters and images overlapping processing configured as the transmitted image data.

12. The image display system as claimed in claim 1, wherein the compressed data is transmitted to reduce system resource at the host end.
